(19) United States
(12) Patent Application Publication
(10) Pub. No.: US 2019/0073340 A1
(43) Pub. Date: Mar. 7, 2019

(54) SYSTEM AND METHOD FOR ADAPTIVELY ADJUSTING EMBEDDED WEBPAGE ELEMENT AND METHOD THEREOF

(71) Applicant: KUN-WEI CHUANG, New Taipei City (TW)

(72) Inventor: KUN-WEI CHUANG, New Taipei City (TW)

(21) Appl. No.: 16/117,446

(22) Filed: Aug. 30, 2018

(30) Foreign Application Priority Data
Sep. 1, 2017 (TW) 106130038

(51) Int. Cl. G06F 17/21

(52) U.S. Cl. CPC G06F 17/212

(57) ABSTRACT

A method for adaptively adjusting an embedded webpage element is provided, which may include the following steps: loading a master program controller by a main webpage; displaying the main webpage by a client device; embedding the embedded webpage element in the main webpage by the master program controller; transmitting the size of the client device to an embedded webpage element server by the master program controller; returning adjustment values of the embedded webpage element to the master program controller according to the size of the client device by the embedded webpage element server, where the adjustment values may include a level adjustment value, a position adjustment value and a size adjustment value; and comparing the adjustment values with the size of the client device by the master program controller so as to adaptively adjust the level, the position and the size of the embedded webpage element.

### CROSS REFERENCE TO RELATED APPLICATION

This application also claims priority to Taiwan Patent Application No. 106130038 filed in the Taiwan Patent Office on Sep. 1, 2017, the entire content of which is incorporated herein by reference.

### TECHNICAL FIELD

The present disclosure relates to a system for adaptively adjusting an embedded webpage element, in particular to a system capable of adaptively adjusting the embedded webpage element and make the visible area thereof conform to the size of the client device. The present disclosure further relates to the method implemented by the system.

### BACKGROUND

Most websites and service platforms provide the source codes of embedded webpage elements (iframe) for other websites or other service platforms to embed these elements. However, if a user wants to adjust the size, the position and the level of an embedded webpage element after the embedded webpage is embedded into a main webpage, the user should have skill in website program development, such as Javascript, HTML, CSS, etc., so as to modify the program of the website to adjust the size, the position and the level of the embedded webpage element. Besides, it is very difficult and time-consuming to develop the program of a website. Accordingly, establishing a website by embedded webpage elements is extremely inefficient for now.

Currently, some websites and service platforms already provide the visualization functions for zooming in, zooming out or dragging embedded webpage elements. However, only some special-purpose websites and service platforms provide these functions and these functions are designed for only one device, so cannot be used to adjust the embedded webpage elements according to the sizes of different devices. Thus, it is very inconvenient for users to establish websites by embedded webpage elements.

Moreover, as described above, although some websites and service platforms provide the visualization functions for zooming in, zooming out or dragging embedded webpage elements, the above functions cannot be applied to the other different platforms or systems. Therefore, the application of establishing websites by embedded webpage elements is limited for now.

Accordingly, it has become an important issue to provide a method for adaptively adjust embedded webpage elements in order to solve the above problems.

### SUMMARY

The present disclosure is related to a system for adaptively adjusting embedded webpage element and the method thereof. In one embodiment of the disclosure, the system for adaptively adjusting embedded webpage element may include a master program controller, a client device and an embedded webpage element server. The master program controller may be loaded by a main webpage. The client device may display the main webpage. The master program controller may embed an embedded webpage element in the main webpage and transmit the size of the client device to the embedded webpage element server. The embedded webpage element server may return the adjustment values of the embedded webpage element to the master program controller according to the size of the client device, wherein the adjustment values of the embedded webpage element may include the level adjustment value, the position adjustment value and the size adjustment value of the embedded webpage element. The master program controller may compare the embedded webpage element with the size of the client device so as to adaptively adjust the level, the position and the size of the embedded webpage element.

In one embodiment of the disclosure, the method for adaptively adjusting embedded webpage element may include the following steps: loading a master program controller by a main webpage; displaying the main webpage by a client device; embedding an embedded webpage element in the main webpage by the master program controller; transmitting the size of the client device to an embedded webpage element server by the master program controller; returning the adjustment values of the embedded webpage element to the master program controller according to the size of the client device by the embedded webpage element server, wherein the adjustment values of the embedded webpage element may include the level adjustment value, the position adjustment value and the size adjustment value of the embedded webpage element; and comparing the adjustment values of the embedded webpage element with the size of the client device by the master program controller so as to adaptively adjust the level, the position and the size of the embedded webpage element.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a block diagram of a system for adaptively adjusting embedded webpage element in accordance with a first embodiment of the present disclosure.

FIG. 2˜FIG. 3 are flow charts of the system for adaptively adjusting embedded webpage element in accordance with the first embodiment of the present disclosure.

FIG. 4 is a first flow chart of a system for adaptively adjusting embedded webpage element in accordance with a second embodiment of the present disclosure.

FIG. 5 is a second flow chart of the system for adaptively adjusting embedded webpage element in accordance with the second embodiment of the present disclosure.

FIG. 6 is a block diagram of a system for adaptively adjusting embedded webpage element in accordance with a third embodiment of the present disclosure.

FIG. 7 is a flow chart of the system for adaptively adjusting embedded webpage element in accordance with the third embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

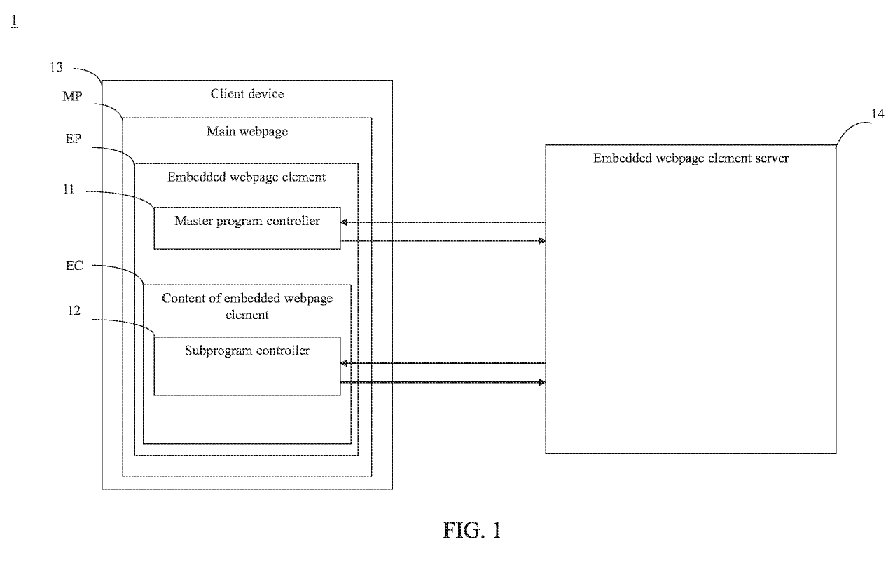

Please refer to FIG. 1, which is a block diagram of a system for adaptively adjusting embedded webpage element in accordance with a first embodiment of the present disclosure. The system 1 for adaptively adjusting embedded webpage element includes a master program controller 11, a client device 13, an embedded webpage element server 14 and a subprogram controller 12.

The master program controller 11 is loaded by a main webpage MP; in a preferred embodiment, the master program controller may be a software control program, which may be controlled by a webpage server.

The client device 13 displays the main webpage MP; in a preferred embodiment, the client device 13 may be a smart phone, a tablet computer, a notebook computer, a personal computer or the other similar devices.

The master program controller 11 embeds the embedded webpage element EP in the main webpage MP and transmits the size of the client device 13 to the embedded webpage element server 14; in a preferred embodiment, the master program controller 11 may be a software control program, which may be controlled by the embedded webpage element server 14.

The embedded webpage element server 14 determines the adjustment values of the embedded webpage element EP according to the size of the client device 13 and then returns the adjustment values of the embedded webpage element EP to the master program controller 11. More specifically, the embedded webpage element server 14 divides the difference between the adjustment values of the embedded webpage element EP and the size of the client device 13 into a plurality of brackets and each bracket includes the adjustment values corresponding thereto, such that the embedded webpage element server 14 can determine which bracket is corresponding to the difference between the embedded webpage element EP and the size of the client device 13 to select the adjustment values corresponding to this bracket and then return the level, the position and the size of the embedded webpage element EP to the master program controller 11 according to the selected adjustment values. The aforementioned adjustment values of the embedded webpage element EP include the level adjustment value, the position adjustment value and the size adjustment value of the embedded webpage element EP.

Afterward, the master program controller 11 compares the adjustment values of the embedded webpage element EP with the size of the client device 13. If the master program controller 11 determines that the adjustment values of the embedded webpage element EP conform to the size of the client device 13, the master program controller 11 adjusts the level, the position and the size of the embedded webpage element EP according to the adjustment values of the embedded webpage element EP. If the master program controller 11 determines that the adjustment values of the embedded webpage element EP fail to conform to the size of the client device 13, the master program controller 11 adjusts the level, the position and the size of the embedded webpage element EP according to the bracket of the difference between the adjustment values of the embedded webpage element EP and the size of the client device 13. More specifically, the master program controller 11 divides the difference between the adjustment values of the embedded webpage element EP and the size of the client device 13 into a plurality of brackets (thresholds) and each bracket includes the adjustment values corresponding thereto, In this way, the master program controller 11 can determine which bracket is corresponding to the difference between the adjustment values of the embedded webpage element EP and the size of the client device 13 to select the adjustment values corresponding to this bracket and then adjust the level, the position and the size of the embedded webpage element EP according to the selected adjustment values.

If the master program controller 11 cannot read the adjustment values of the embedded webpage element EP from the embedded webpage element server 14, the master program controller 11 reads the default adjustment values of the embedded webpage element EP from the embedded webpage element server 14 and then compare which with the size of the client device 13. If the master program controller 11 determines that the default adjustment values of the embedded webpage element EP conform to the size of the client device 13, the master program controller 11 adjusts the level, the position and the size of the embedded webpage element EP according to the default adjustment values of the embedded webpage element EP. If the master program controller 11 determines that the default adjustment values of the embedded webpage element EP fail to conform to the size of the client device 13, the master program controller 11 adjusts the level, the position and the size of the embedded webpage element EP according to the bracket of the difference between the default adjustment values of the embedded webpage element EP and the size of the client device 13.

As described above, after receiving the size of the client device 13, the embedded webpage element server 14 returns the adjustment values of the content EC of the embedded webpage element EP to the subprogram controller 12 according to the size of the client device 13. More specifically, the embedded webpage element server 14 divides the difference between the adjustment values of the content EC of the embedded webpage element EP and the size of the client device 13 into a plurality of brackets and each bracket includes the adjustment values corresponding thereto, such that the embedded webpage element server 14 can determine which bracket is corresponding to the difference between the content EC of the embedded webpage element EP and the size of the client device 13 to select the adjustment values corresponding to this bracket and then return the level, the position and the size of the content EC of the embedded webpage element EP to the subprogram program controller 12 according to the selected adjustment values. Similarly, the aforementioned adjustment values of the content EC of the embedded webpage element EP include the level adjustment value, the position adjustment value and the size adjustment value of the content EC of the embedded webpage element EP.

Then, the subprogram controller 12 compares the adjustment values of the content EC of the embedded webpage element EP with the size of the client device 13. If the subprogram controller 12 determines that the adjustment values of the content EC of the embedded webpage element EP conform to the size of the client device 13, the subprogram controller 12 adjusts the level, the position and the size of the content EC of the embedded webpage element EP according to the adjustment values of the content EC of the embedded webpage element EP. If the subprogram controller 12 determines that the adjustment values of the content EC of the embedded webpage element EP fail to conform to the size of the client device 13, the subprogram controller 12 adjusts the level, the position and the size of the content EC of the embedded webpage element EP according to the bracket of the difference between the adjustment values of the content EC of the embedded webpage element EP and the size of the client device 13. More specifically, the subprogram controller 12 divides the difference between the adjustment values of the content EC of the embedded webpage element EP and the size of the client device 13 into a plurality of brackets (thresholds) and each bracket includes the adjustment values corresponding thereto, In this way, the subprogram controller 11 can determine which bracket is corresponding to the difference between the content EC of the embedded webpage element EP and the size of the client device 13 to select the adjustment values corresponding to this bracket and then adjust the level, the position and the size of the content EC of the embedded webpage element EP according to the selected adjustment values.

If the subprogram controller 12 cannot read the adjustment values of the content EC of the embedded webpage element EP from the embedded webpage element server 14, the subprogram controller 12 reads the default adjustment values of the content EC of the embedded webpage element EP from the embedded webpage element server 14 and then compare which with the size of the client device 13. If the subprogram controller 12 determines that the default adjustment values of the content EC of the embedded webpage element EP conform to the size of the client device 13, the subprogram controller 12 adjusts the level, the position and the size of the content EC of the embedded webpage element EP according to the default adjustment values of the content EC of the embedded webpage element EP. If the subprogram controller 12 determines that the default adjustment values of the content EC of the embedded webpage element EP fail to conform to the size of the client device 13, the subprogram controller 12 adjusts the level, the position and the size of the content EC of the embedded webpage element EP according to the bracket of the difference between the default adjustment values of the content EC of the embedded webpage element EP and the size of the client device 13.

In this way, the system 1 can automatically and adaptively adjust the level, the position and the size of the embedded webpage element EP to make the embedded webpage element EP conform to the client devices 13 with difference sizes. The system 1 can be applied to different platforms and systems, so is more convenient in use and more comprehensively in application.

The embodiment just exemplifies the present disclosure and is not intended to limit the scope of the present disclosure; any equivalent modification and variation according to the spirit of the present disclosure is to be also included within the scope of the following claims and their equivalents.

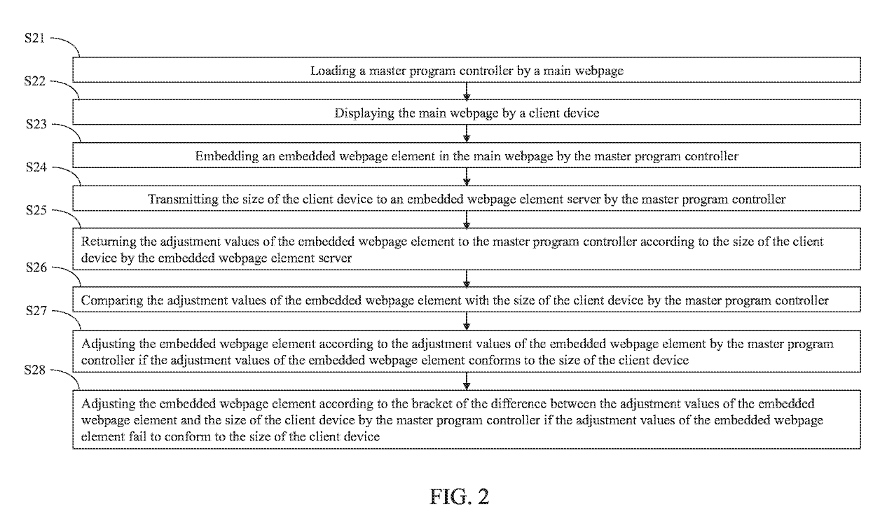

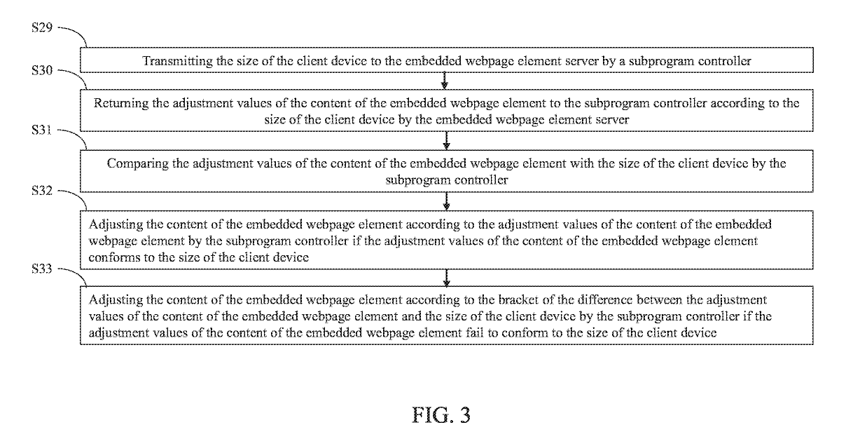

Please refer to FIG. 2, which is a flow chart of the system for adaptively adjusting embedded webpage element in accordance with the first embodiment of the present disclosure. The method of the system 1 for adaptively adjusting embedded webpage element of the embodiment includes the following step:

Step S21: loading a master program controller by a main webpage.

Step S22: displaying the main webpage by a client device.

Step S23: embedding an embedded webpage element in the main webpage by the master program controller.

Step S24: transmitting the size of the client device to an embedded webpage element server by the master program controller.

Step S25: returning the adjustment values of the embedded webpage element to the master program controller according to the size of the client device by the embedded webpage element server.

Step S26: comparing the adjustment values of the embedded webpage element with the size of the client device by the master program controller.

Step S27: adjusting the embedded webpage element according to the adjustment values of the embedded webpage element by the master program controller if the adjustment values of the embedded webpage element conforms to the size of the client device.

Step S28: adjusting the embedded webpage element according to the bracket of the difference between the adjustment values of the embedded webpage element and the size of the client device by the master program controller if the adjustment values of the embedded webpage element fail to conform to the size of the client device.

Please refer to FIG. 3, which is a flow chart of the system for adaptively adjusting embedded webpage element in accordance with the first embodiment of the present disclosure. The method of the system 1 for adaptively adjusting embedded webpage element of the embodiment further includes the following step:

Step S29: transmitting the size of the client device to the embedded webpage element server by a subprogram controller.

Step S30: returning the adjustment values of the content of the embedded webpage element to the subprogram controller according to the size of the client device by the embedded webpage element server.

Step S31: comparing the adjustment values of the content of the embedded webpage element with the size of the client device by the subprogram controller.

Step S32: adjusting the content of the embedded webpage element according to the adjustment values of the content of the embedded webpage element by the subprogram controller if the adjustment values of the content of the embedded webpage element conforms to the size of the client device

Step S33: adjusting the content of the embedded webpage element according to the bracket of the difference between the adjustment values of the content of the embedded webpage element and the size of the client device by the subprogram controller if the adjustment values of the content of the embedded webpage element fail to conform to the size of the client device.

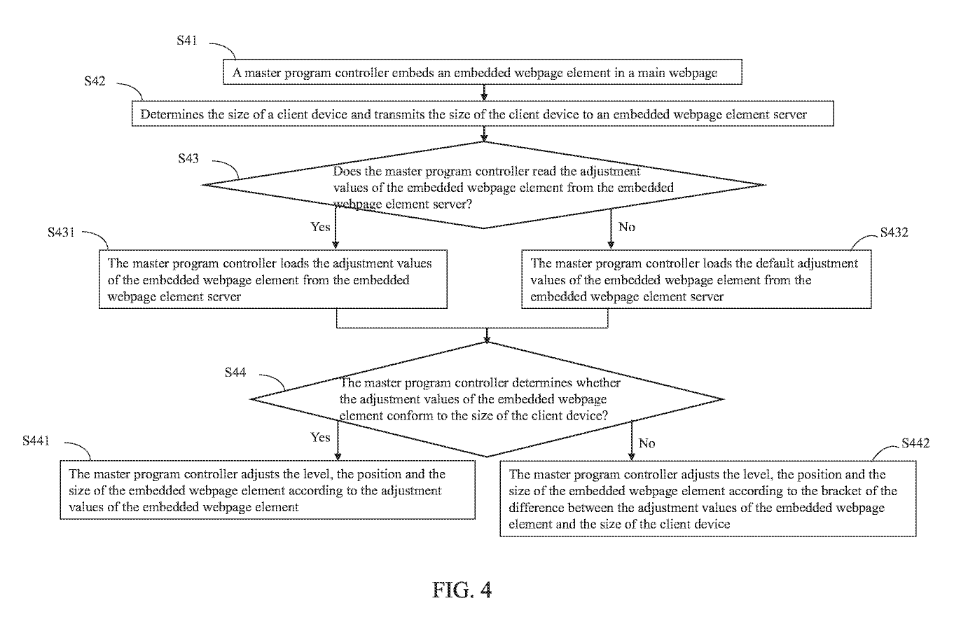

Please refer to FIG. 4, which is a first flow chart of a system for adaptively adjusting embedded webpage element in accordance with a second embodiment of the present disclosure. In order to more clearly describe that the method for adaptively adjust embedded webpage element of the embodiment can automatically and adaptively adjust the level, the position and the size of an embedded webpage element to make the embedded webpage element conform to the size of a client device, the embodiment illustrates the method by the following steps:

Step S41: a master program controller embeds an embedded webpage element in a main webpage; then, the process proceeds to Step S42.

Step S42: the master program controller determines the size of a client device and transmits the size of the client device to an embedded webpage element server;

then, the process proceeds to Step S43.

Step S43: Does the master program controller read the adjustment values of the embedded webpage element from the embedded webpage element server? If it does, the process proceeds to Step 431; if it does not, the process proceeds to Step 432.

Step S431: the master program controller loads the adjustment values of the embedded webpage element from the embedded webpage element server; then, the process proceeds to Step S44.

Step S432: the master program controller loads the default adjustment values of the embedded webpage element from the embedded webpage element server; then, the process proceeds to Step S44.

Step S44: the master program controller compares the adjustment values of the embedded webpage element with the size of the client device; if the adjustment values conform to the size of the client device, the process proceeds to Step S441; if the adjustment values fail to conform to the size of the client device, the process proceeds to Step S442,

Step S441: the master program controller adjusts the level, the position and the size of the embedded webpage element according to the adjustment values of the embedded webpage element.

Step S442: the master program controller adjusts the level, the position and the size of the embedded webpage element according to the bracket of the difference between the adjustment values of the embedded webpage element and the size of the client device.

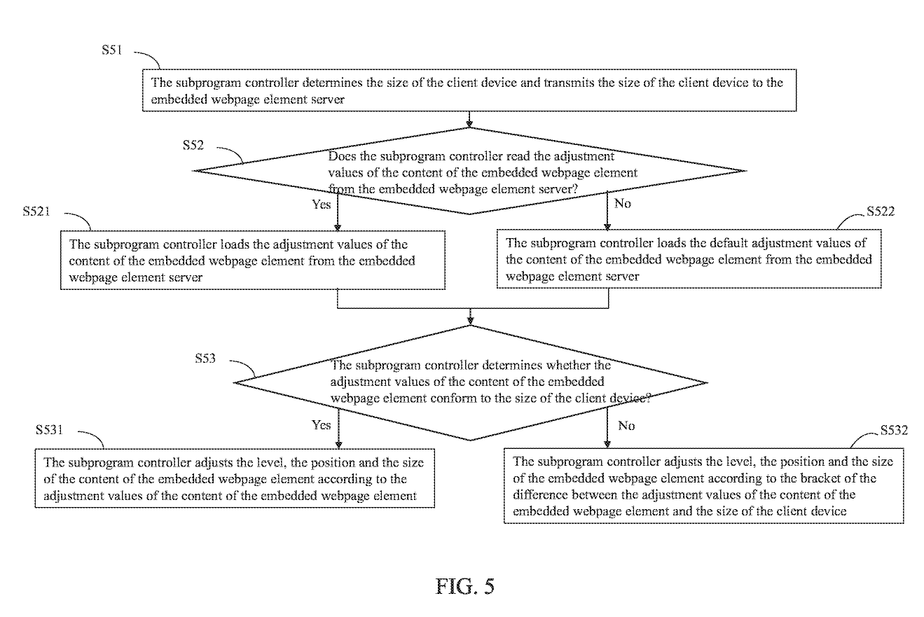

Please refer to FIG. 5, which is a second flow chart of the system for adaptively adjusting embedded webpage element in accordance with the second embodiment of the present disclosure. In order to more clearly describe that the method for adaptively adjust embedded webpage element of the embodiment can automatically and adaptively adjust the level, the position and the size of an embedded webpage element to make the embedded webpage element conform to the size of a client device, the embodiment further illustrates the method by the following steps:

Step S51: the subprogram controller determines the size of the client device and transmits the size of the client device to the embedded webpage element server; then, the process proceeds to Step S52.

Step S52: Does the subprogram controller read the adjustment values of the content of the embedded webpage element from the embedded webpage element server? If it does, the process proceeds to Step 521; if it does not, the process proceeds to Step 522.

Step S521: the subprogram controller loads the adjustment values of the content of the embedded webpage element from the embedded webpage element server; then, the process proceeds to Step S53.

Step S522: the subprogram controller loads the default adjustment values of the content of the embedded webpage element from the embedded webpage element server; then, the process proceeds to Step S53.

Step S53: the subprogram controller compares the adjustment values of the content of the embedded webpage element with the size of the client device; if the adjustment values conform to the size of the client device, the process proceeds to Step S531; if the adjustment values fail to conform to the size of the client device, the process proceeds to Step S532.

Step S531: the subprogram controller adjusts the level, the position and the size of the content of the embedded webpage element according to the adjustment values of the content of the embedded webpage element.

Step S532: the subprogram controller adjusts the level, the position and the size of the embedded webpage element according to the bracket of the difference between the adjustment values of the content of the embedded webpage element and the size of the client device.

The embodiment just exemplifies the present disclosure and is not intended to limit the scope of the present disclosure; any equivalent modification and variation according to the spirit of the present disclosure is to be also included within the scope of the following claims and their equivalents.

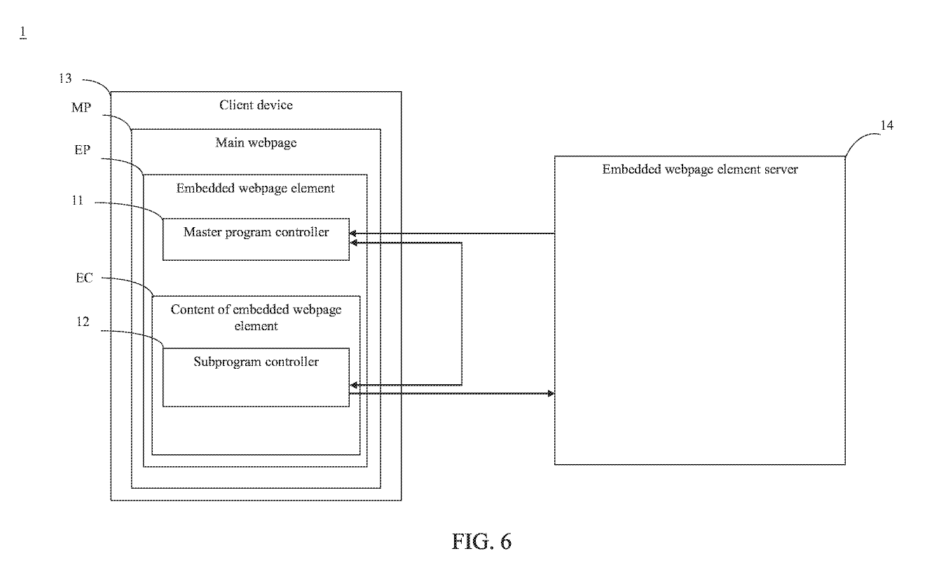

Please refer to FIG. 6, which is a block diagram of a system for adaptively adjusting embedded webpage element in accordance with a third embodiment of the present disclosure. The system 1 for adaptively adjusting embedded webpage element includes a master program controller 11, a client device 13, an embedded webpage element server 14 and a subprogram controller 12.

Similarly, the system 1 can also automatically and adaptively adjust the levels, the positions and the sizes of an embedded webpage element EP and the content EC thereof in order to conform to the size of the client device 13, as described in the previous embodiments.

The difference between the embodiment and the previous embodiment is that the system 1 of the embodiment can further allow a user to freely adjust the level, the position and the size of the content EC of the embedded web element EP via the system 1 in order to satisfy different requirements.

The user can select the zoom-in, zoom-out and dragging functions of the embedded web element EP via the client device 13. Meanwhile, the subprogram controller 12 transmits the adjustment instruction of the embedded web element EP to the master program controller 11. Then, the master program controller 11 saves the original level, the original position and the original size of the embedded web element EP in a browser or the embedded web element server 14.

After the browser or the embedded web element server 14 saves the original level, the original position and the original size of the embedded web element EP, the master program controller 11 adjusts the size of the embedded web element EP to make the size of the embedded web element EP be equal to the size of the main webpage MP. Meanwhile, the subprogram controller 12 sets the content EC of the embedded web element EP to be in an adjustable status.

Next, the user can use the client device 13 to adjust the level setting value, the position setting value and the size setting value of the content EC of the embedded webpage element EP via the visualization zoom-in, zoom-out and dragging functions, and then transmit the level setting value, the position setting value and the size setting value of the content EC of the embedded webpage element EP to the embedded webpage element server 14.

Afterward, the subprogram controller 12 disables the adjustable status of the content EC of the embedded webpage element EP, and then transmits a recovery instruction to the master program controller 11.

Finally, the master program controller 11 reads the level setting value, the position setting value and the size setting value of the content EC of the embedded webpage element EP from the embedded webpage element server 14 in order to adjust the level, the position and the size of the content EC of the embedded webpage element EP.

As described above, the system 1 allows the user to swiftly and properly adjust the level, the position and the size of the content EC of the embedded webpage element EP in the main webpage MP according to the size of the client device 13 by the visualization zoom-in, zoom-out and dragging functions even if the user does not have skill in website program development, which can significantly increase the efficiency of establish websites.

In addition, the embedded webpage element EP of the embodiment can further connect to a payment flow system (not shown in the drawings). The user can embed the information of his/her products for sales in the main webpage MP and make transactions with buyers. The buyers can also make the payments or the other transactions via the payment flow system. As described above, the system allows the user not having skill in website program development to establish his/her personal on-line shop webpage and make the transactions with the buyers via the payment flow system, which is not only more convenient in use, but also can significantly better the security of network transaction.

The embodiment just exemplifies the present disclosure and is not intended to limit the scope of the present disclosure; any equivalent modification and variation according to the spirit of the present disclosure is to be also included within the scope of the following claims and their equivalents.

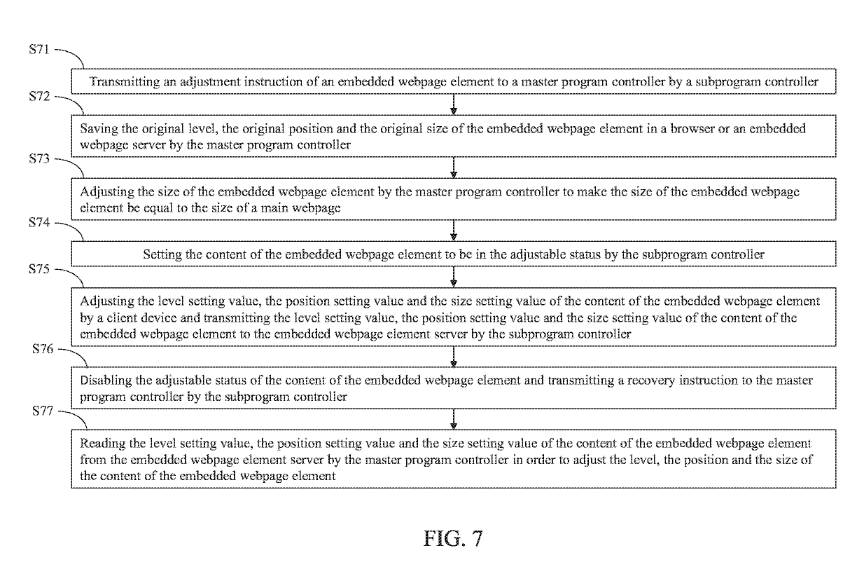

Please refer to FIG. 7, which is a flow chart of the system for adaptively adjusting embedded webpage element in accordance with the third embodiment of the present disclosure. The method of the system 1 for adaptively adjusting embedded webpage element of the embodiment includes the following step:

Step S71: transmitting an adjustment instruction of an embedded webpage element to a master program controller by a subprogram controller.

Step S72: saving the original level, the original position and the original size of the embedded webpage element in a browser or an embedded webpage server by the master program controller.

Step S73: adjusting the size of the embedded webpage element by the master program controller to make the size of the embedded webpage element be equal to the size of a main webpage.

Step S74: setting the content of the embedded webpage element to be in the adjustable status by the subprogram controller.

Step S75: adjusting the level setting value, the position setting value and the size setting value of the content of the embedded webpage element by a client device and transmitting the level setting value, the position setting value and the size setting value of the content of the embedded webpage element to the embedded webpage element server by the subprogram controller.

Step S76: disabling the adjustable status of the content of the embedded webpage element and transmitting a recovery instruction to the master program controller by the subprogram controller.

Step S77: reading the level setting value, the position setting value and the size setting value of the content of the embedded webpage element from the embedded webpage element server by the master program controller in order to adjust the level, the position and the size of the content of the embedded webpage element.

To sum up, according to one embodiment of the present disclosure, the system for adaptively adjusting embedded webpage element can automatically adjust the level, the position and the size of an embedded webpage element and the content thereof after embedding the embedded webpage element in a main webpage, so the embedded webpage element can conform to the size of the client device, which is more convenient in use.

Besides, according to one embodiment of the present disclosure, the system for adaptively adjusting embedded webpage element allows a user to swiftly and properly adjust the level, the position and the size of an embedded webpage element in a main webpage according to the size of the user's electronic device (client device) by the visualization zoom-in, zoom-out and dragging functions even if the user does not have skill in website program development, which can significantly increase the efficiency of establish websites.

Moreover, according to one embodiment of the present disclosure, the system for adaptively adjusting embedded webpage element can be directly applied to various systems and platforms, which is more comprehensively in application.

Furthermore, according to one embodiment of the present disclosure, the system for adaptively adjusting embedded webpage element allows an embedded webpage element to be connected to a payment flow system, so a user can directly use the website established by the user and the payment flow system to sell products and make transactions, which is not only more convenient in use, but also can better the security of network transaction.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A system for adaptively adjusting embedded webpage element, comprising:
a master program controller, loaded by a main webpage;
a client device, configured to display the main webpage;
an embedded webpage element server;
wherein the master program controller embeds an embedded webpage element in the main webpage and transmits a size of the client device to the embedded webpage element server; the embedded webpage element server returns adjustment values of the embedded webpage element to the master program controller according to the size of the client device, wherein the adjustment values of the embedded webpage element includes a level adjustment value, a position adjustment value and a size adjustment value of the embedded webpage element; the master program controller compares the adjustment values of the embedded webpage element with the size of the client device so as to adaptively adjust a level, a position and a size of the embedded webpage element.

2. The system of claim 1, wherein if the adjustment values of the embedded webpage element conforms to the size of the client device, the master program controller adjusts the embedded webpage element according to the adjustment values of the embedded webpage element.

3. The system of claim 1, wherein if the adjustment values of the embedded webpage element fail to conform to the size of the client device, the master program controller adjusts the embedded webpage element according to a bracket of a difference between the adjustment values of the embedded webpage element and the size of the client device.

4. The system of claim 1, further comprising a subprogram controller, wherein the subprogram controller transmits the size of the client device to the embedded webpage element server and the embedded webpage element server returns adjustment values of a content of the embedded webpage element to the subprogram controller according to the size of the client device; the subprogram controller compares the adjustment values of the content of the embedded webpage element with the size of the client device in order to adaptively adjust a level, a position and a size of the content of the embedded webpage element.

5. The system of claim 4, wherein the subprogram controller transmits an adjustment instruction of the embedded webpage element to the master program controller and the master program controller saves an original level, an original position and an original size of the embedded webpage element in a browser or the embedded webpage server.

6. The system of claim 1, wherein the embedded webpage element is connected to a payment flow system.

7. The system of claim 4, wherein if the adjustment values of the content of the embedded webpage element conform to the size of the client device, the subprogram controller adjusts the content of the embedded webpage element according to the adjustment values of the content of the embedded webpage element.

8. The system of claim 4, wherein if the adjustment values of the content of the embedded webpage element fail to conform to the size of the client device, the subprogram controller adjusts the content of the embedded webpage element according to a bracket of a difference between the adjustment values of the content of the embedded webpage element and the size of the client device.

9. The system of claim 5, wherein the master program controller adjusts the size of the embedded webpage element to make the size of the embedded webpage element be equal to a size of the main webpage and the subprogram controller sets the content of the embedded webpage element to be in an adjustable status after the browser or the embedded webpage element server saves the original level, the original position and the original size of the embedded webpage element.

10. The system of claim 9, wherein the client device adjusts a level setting value, a position setting value and a size setting value of the content of the embedded webpage element and the subprogram controller transmits the level setting value, the position setting value and the size setting value of the content of the embedded webpage element to the embedded webpage element server after the subprogram controller sets the content of the embedded webpage element to be in the adjustable status.

11. The system of claim 10, wherein the subprogram controller disables the adjustable status of the content of the embedded webpage element and transmits a recovery instruction to the master program controller after the embedded webpage element server receives the level setting value, the position setting value and the size setting value of the content of the embedded webpage element.

12. The system of claim 11, wherein the master program controller reads the level setting value, the position setting value and the size setting value of the content of the embedded webpage element from the embedded webpage element server in order to adjust the level, the position and the size of the content of the embedded webpage element after the master program controller receives the recovery instruction.

13. A method for adaptively adjusting embedded webpage element, comprising:
loading a master program controller by a main webpage;
displaying the main webpage by a client device;
embedding an embedded webpage element in the main webpage by the master program controller;
transmitting a size of the client device to an embedded webpage element server by the master program controller;
returning adjustment values of the embedded webpage element to the master program controller according to the size of the client device by the embedded webpage element server, wherein the adjustment values of the embedded webpage element includes a level adjustment value, a position adjustment value and a size adjustment value of the embedded webpage element; and
comparing the adjustment values of the embedded webpage element with the size of the client device by the master program controller so as to adaptively adjust a level, a position and a size of the embedded webpage element.

14. The method of claim 13, wherein a step of comparing the adjustment values of the embedded webpage element with the size of the client device by the master program controller further comprises:
adjusting the embedded webpage element according to the adjustment values of the embedded webpage element by the master program controller if the adjustment values of the embedded webpage element conforms to the size of the client device.

15. The method of claim 13, wherein a step of comparing the adjustment values of the embedded webpage element with the size of the client device by the master program controller further comprises a following step:
adjusting the embedded webpage element according to a bracket of a difference between the adjustment values of the embedded webpage element and the size of the client device by the master program controller if the adjustment values of the embedded webpage element fail to conform to the size of the client device.

16. The method of claim 13, further comprising:
transmitting the size of the client device to the embedded webpage element server by a subprogram controller;
returning adjustment values of a content of the embedded webpage element to the subprogram controller according to the size of the client device by the embedded webpage element server; and
comparing the adjustment values of the content of the embedded webpage element with the size of the client device by the subprogram controller in order to adaptively adjust a level, a position and a size of the content of the embedded webpage element.

17. The method of claim 16, further comprising:
transmitting an adjustment instruction of the embedded webpage element to the master program controller by the subprogram controller.

18. The method of claim 13, further comprising:
connecting the embedded webpage element to a payment flow system.

19. The method of claim 16, wherein a step of comparing the adjustment values of the embedded webpage element with the size of the client device by the subprogram controller further comprises:
adjusting the content of the embedded webpage element according to the adjustment values of the content of the embedded webpage element by the subprogram controller if the adjustment values of the content of the embedded webpage element conforms to the size of the client device.

20. The method of claim 16, wherein a step of comparing the adjustment values of the embedded webpage element with the size of the client device by the subprogram controller further comprises:
adjusting the content of the embedded webpage element according to a bracket of a difference between the adjustment values of the content of the embedded webpage element and the size of the client device by the subprogram controller if the adjustment values of the content of the embedded webpage element fail to conform to the size of the client device.

21. The method of claim 17, further comprising:
saving an original level, an original position and an original size of the embedded webpage element in a browser or the embedded webpage server by the master program controller.

22. The method of claim 21, further comprising:
adjusting the size of the embedded webpage element by the master program controller to make the size of the embedded webpage element be equal to a size of the main webpage.

23. The method of claim 22, further comprising:
setting the content of the embedded webpage element to be in an adjustable status by the subprogram controller.

24. The method of claim 23, further comprising:
adjusting a level setting value, a position setting value and a size setting value of the content of the embedded webpage element by the client device and transmitting the level setting value, the position setting value and the size setting value of the content of the embedded webpage element to the embedded webpage element server by the subprogram controller.

25. The method of claim 24, further comprising:
disabling the adjustable status of the content of the embedded webpage element and transmitting a recovery instruction to the master program controller by the subprogram controller.

26. The method of claim 25, further comprising:
reading the level setting value, the position setting value and the size setting value of the content of the embedded webpage element from the embedded webpage element server by the master program controller in order to adjust the level, the position and the size of the content of the embedded webpage element.
